(19) United States
(12) Patent Application Publication
(10) Pub. No.: US 2022/0226998 A1
(43) Pub. Date: Jul. 21, 2022

(54) METHOD AND APPARATUS FOR TRACING FAULT OF COLLABORATIVE ROBOT

(71) Applicant: AJOU UNIVERSITY INDUSTRY-ACADEMIC COOPERATION FOUNDATION, Suwon-si (KR)

(72) Inventors: Jung Won Lee, Seoul (KR); Ye Seul Park, Incheon (KR); Dong Yeon Yoo, Suwon-si (KR)

(73) Assignee: AJOU UNIVERSITY INDUSTRY-ACADEMIC COOPERATION FOUNDATION, Suwon-si (KR)

(21) Appl. No.: 17/568,321

(22) Filed: Jan. 4, 2022

(30) Foreign Application Priority Data
Jan. 15, 2021 (KR) 10-2021-0005875

(51) Int. Cl. B25J 9/16

(52) U.S. Cl. CPC B25J 9/1674; B25J 9/1653; B25J 9/1664

(57) ABSTRACT

The present invention relates to a method and apparatus for tracing a fault of a collaborative robot, including the steps of setting, by an electronic device, a basic index which serves as an analysis criterion of operational data generated by the collaborative robot, setting, by the electronic device, an analysis index for analyzing the operational data, receiving, by the electronic device, a plurality of operational data from the collaborative robot, and tracing, by the electronic device, a fault generated in at least one of the plurality of operational data using the basic index and the analysis index, and the application to other exemplary embodiments is possible.

### CROSS-REFERENCE TO RELATED APPLICATION

This application claims priority to and the benefit of Korean Patent Application No. 10-2021-0005875, filed on Jan. 15, 2021, the disclosure of which is incorporated herein by reference in its entirety.

### TECHNICAL FIELD

The present invention relates to a method and apparatus for tracing a fault of a collaborative robot.

### BACKGROUND ART

The smart factory refers to an intelligent production factory that can improve productivity, quality and customer satisfaction by combining the information and communications technology (ICT), in which digital automation solutions are combined, with industrial robots in the production process of design, development, manufacturing, distribution, logistics and the like. Such smart factories are being implemented mainly by major conglomerates.

However, since industrial robots operated in the existing factories are designed to perform the same motion, there is a problem in that when the design of the product is changed or the type of product is changed, the operation of the industrial robot itself needs to be changed. In addition, most small and medium-sized companies lack the conditions or capabilities to promote the smart factory on their own, making it difficult to apply the smart factory, and there is a problem in that workers at small and medium-sized companies, whose working environment is poorer than that of major conglomerates, are continuously exposed to poor working conditions.

For this reason, recently, the smart factory is sometimes implemented by using a collaborative robot which is programmed to perform various tasks, and since such a collaborative robot performs various tasks, the work complexity is high, and thus, since sensing data is acquired without distinction of the tasks performed by the collaborative robot, it is not easy to analyze the status of the collaborative robot using only the sensing data. In addition, there is a problem in that it is not easy to trace the cause of a fault generated in the collaborative robot only with the sensing data.

### DISCLOSURE

### Technical Problem

The exemplary embodiments of the present invention for solving the aforementioned conventional problems are directed to providing a method and apparatus for tracing a fault of a collaborative robot that can identify the cause of a fault when the fault is detected in the collaborative robot.

In addition, the exemplary embodiments of the present invention are directed to providing a method and apparatus for tracing a fault of a collaborative robot that can accurately identify the cause of a fault at the time of detecting the fault by defining the tasks performed by the collaborative robot and the motions constituting the corresponding tasks in an index hierarchy structure.

### Technical Solution

The method for tracing a fault of a collaborative robot according to an exemplary embodiment of the present invention includes the steps of setting, by an electronic device, a basic index which serves as an analysis criterion of operational data generated by the collaborative robot, setting, by the electronic device, an analysis index for analyzing the operational data, receiving, by the electronic device, a plurality of operational data from the collaborative robot, and tracing, by the electronic device, a fault generated in at least one of the plurality of operational data using the basic index and the analysis index.

In addition, the step of setting the basic index is setting a boot, a program ID, a motion ID, an execution index, a program execution index and a motion execution index associated with the operation of the collaborative robot as the basic index.

In addition, the step of setting the analysis index is setting an analysis ID that combines the program ID and the motion ID, a first analysis index that combines the program execution index and the motion ID, and a second analysis index that combines the first analysis index and the motion execution index.

In addition, the step of tracing the fault includes assigning, by the electronic device, the basic index and the analysis index to each of the plurality of operational data.

In addition, after the step of assigning the basic index and the analysis index, the method further includes confirming, by the electronic device, a second analysis index having the same analysis ID from among the analysis indexes assigned to each of the plurality of operational data.

In addition, after the step of assigning the basic index and the analysis index, the method further includes confirming, by the electronic device, a second analysis index having the same first analysis index from among the first analysis indexes assigned to each of the plurality of operational data.

In addition, the method further includes confirming each of a plurality of data values for each of a plurality of operational data corresponding to the confirmed second analysis index, confirming a data value which is different by a threshold or more from among the plurality of data values, and tracing the fault by confirming programs and motions associated with the confirmed data value.

Moreover, the apparatus for tracing a fault of a collaborative robot according to an exemplary embodiment of the present invention includes a communicator for receiving a plurality of operational data from the collaborative robot, and a controller for setting a basic index which serves as an analysis criterion of the operational data and an analysis index for analyzing the operational data, and tracing a fault generated in at least one of the plurality of operational data using the basic index, the analysis index and the plurality of operational data.

In addition, the basic index includes a boot, a program ID, a motion ID, an execution index, a program execution index and a motion execution index associated with the operation of the collaborative robot.

In addition, the analysis index includes an analysis ID that combines the program ID and the motion ID, a first analysis index that combines the program execution index and the motion ID, and a second analysis index that combines the first analysis index and the motion execution index.

In addition, the controller assigns the basic index and the analysis index to each of the plurality of operational data.

In addition, the controller respectively confirms a second analysis index having the same analysis ID or the same first analysis index from among the analysis indexes assigned to each of the plurality of operational data.

In addition, the controller confirms each of a plurality of data values for each of a plurality of operational data corresponding to the confirmed second analysis index.

In addition, the controller traces the fault by confirming programs and motions associated with a data value which is different by a threshold or more from among the plurality of confirmed data values.

### Advantageous Effects

As described above, by identifying the cause of a fault when the fault is detected in the collaborative robot, the method and apparatus for tracing a fault of a collaborative robot according to the present invention have effects of expanding the range of possible fault diagnosis of the collaborative robot and enabling efficient maintenance management.

In addition, by defining the tasks performed by the collaborative robot and the motions constituting the corresponding tasks in an index hierarchy structure, the method and apparatus for tracing a fault of a collaborative robot according to the present invention have an effect of accurately identifying the cause of a fault based on the index at the time of detecting the fault in the collaborative robot.

### DESCRIPTION OF DRAWINGS

FIG. 1 is a diagram illustrating the system for tracing a fault of a collaborative robot according to an exemplary embodiment of the present invention.

FIG. 2 is a diagram illustrating the electronic device for tracing a fault of a collaborative robot according to an exemplary embodiment of the present invention.

FIG. 3 is a flowchart illustrating the method for tracing a fault of a collaborative robot according to an exemplary embodiment of the present invention.

FIG. 4 is a diagram for describing an index hierarchical structure set in operational data received from a collaborative robot according to an exemplary embodiment of the present invention.

FIG. 5 is a diagram for describing the operational situation of a collaborative robot in an index hierarchical structure according to an exemplary embodiment of the present invention.

FIG. 6 is a diagram showing the results of analyzing the operational data of a collaborative robot according to an exemplary embodiment of the present invention.

### MODES OF THE INVENTION

Hereinafter, preferred exemplary embodiments according to the present invention will be described in detail with reference to the accompanying drawings. The detailed description set forth below in conjunction with the accompanying drawings is intended to describe the exemplary embodiments of the present invention and is not intended to represent the only exemplary embodiments in which the present invention may be practiced. In order to clearly describe the present invention in the drawings, parts that are not related to the description may be omitted, and the same reference numerals may be used for the same or similar components throughout the specification

In an exemplary embodiment of the present invention, expressions such as “or” “at least one” and the like may indicate one of the words listed together, or a combination of two or more. For example, “A or B” and “at least one of A and B” may include only one of A or B, or both A and B.

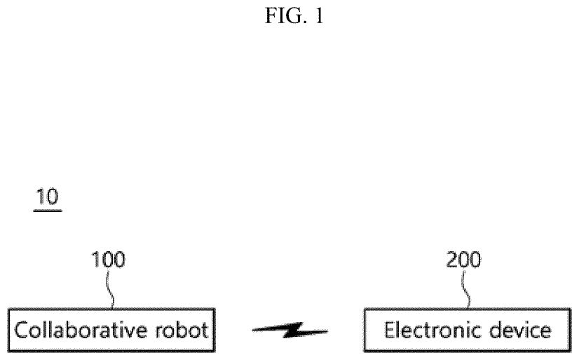

FIG. 1 is a diagram illustrating the system for tracing a fault of a collaborative robot according to an exemplary embodiment of the present invention.

Referring to FIG. 1, the system 10 according to the present invention includes a collaborative robot 100 and an electronic device 200. In addition, although it is described as an example that the electronic device 200 performs communication with one collaborative robot 100 in an exemplary embodiment of the present invention, the present invention is not limited thereto, and it is possible to perform communication with a plurality of collaborative robots.

The collaborative robot 100 is a type of robots that build a smart factory system, and refers to a robot that is put into delicate tasks that require human participation, and performs the tasks in connection with humans. Such a collaborative robot 100 performs various tasks driven by programming rather than predetermined fixed tasks.

Although not illustrated, the collaborative robot 100 includes a plurality of joints and a plurality of sensors provided in at least one of the inside and the outside of each joint. The collaborative robot 100 is operated by the designed programming, and acquires operational data associated with the operation. In this case, the operational data includes sensing data acquired from the sensor and motion data associated with the motion of the collaborative robot 100. The collaborative robot 100 transmits the acquired operational data to the electronic device 200. To this end, the collaborative robot 100 performs at least one of wireless communication and wired communication with the electronic device 200.

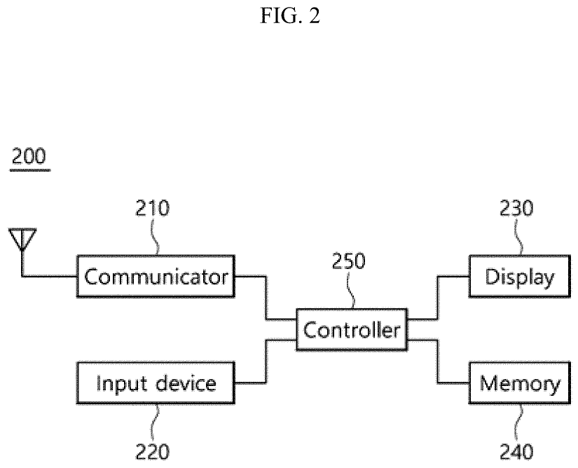

The electronic device 200 is a device such as a computer, a tablet PC or the like, and receives operational data from the collaborative robot 100 through communication of the collaborative robot 100. The electronic device 200 defines the tasks performed by the collaborative robot 100 and the motions constituting the corresponding tasks in an index hierarchical structure based on the received operational data. The main configuration of the electronic device 200 will be described in more detail with reference to FIG. 2 below. FIG. 2 is a diagram illustrating the electronic device for tracing a fault of a collaborative robot according to an exemplary embodiment of the present invention.

Referring to FIG. 2, the electronic device 200 according to the present invention includes a communicator 210, an input device 220, a display 230, a memory 240 and a controller 250.

The communicator 210 receives operational data from the collaborative robot 100 through communication with the collaborative robot 100, and provides the same to the controller 250. To this end, the communicator 210 may perform wireless communication such as 5^{th} generation communication (5G), long term evolution (LTE), long term evolution-advanced (LTE-A) and wireless fidelity (Wi-Fi), and perform wired communication using a cable.

The input device 220 generates input data in response to an input of a user of the electronic device 200. To this end, the input device 220 may include an input device such as a keyboard, a mouse, a keypad, a dome switch, a touch panel, a touch key, a button and the like.

The display 230 outputs output data according to the operation of the electronic device 200. To this end, the display 230 may include a display device such as a liquid crystal display (LCD), a light emitting diode (LED) display, an organic light emitting diode (OLED) display and the like. In addition, the display 230 may be implemented in the form of a touch screen in combination with the input device 220.

The memory 240 stores operation programs of the electronic device 200.

The memory 240 stores the operational data received from the collaborative robot 100, and stores an index hierarchical structure in which the tasks performed by the collaborative robot 100 based on the operational data and the motions constituting the corresponding tasks are defined.

The controller 250 sets a section from the time when the power of the collaborative robot 100 is turned on to the time when the power is turned off as a boot index (boot_idx), sets the type of program to be executed until the power of the collaborative robot 100 is turned on and off as a program ID (program_id), sets the unit of the motion constituting each program as a motion ID (motion_id), sets the unit for executing any one of the motions constituting the program as an execution index (program_idx, motion_idx), sets a program execution index (program_idx) in which a program corresponding to the program ID (program_id) is executed, and sets a motion execution index (motion_idx) in which a motion corresponding to the motion ID (motion_id) is executed as a basic index.

In this case, id may refer to a unique number, and idx may refer to a number that is automatically increased according to repetition. In the case of a boot, program execution and motion execution, the identification unit is created according to the order in which it appears sequentially, and thus, it is set in the form of idx. In addition, since the program and motion vary depending on the constituted contents, the value is assigned in the form of id.

In order to detect a fault of the collaborative robot 100, the controller 250 must group and compare data executed under the same conditions, that is, the same program (program_idx) and the same motion (motion_idx). Therefore, the controller 250 sets the analysis unit as an analysis ID (PM_id), sets the unit for each program execution having the same analysis ID (PM_id) as a first analysis index (PM_idx), and sets the execution section of the motion as a second analysis index (PMI_idx).

In this case, the analysis ID (PM_id) refers to an ID assigned to a motion which is dependent on the executed program. That is, the analysis ID (PM_id) is set by combining the program ID (program_id) and the motion ID (motion_id) dependent on the program ID (program_id). The first analysis index (PM_idx) is set by combining the program execution index (program_idx) and the motion ID (motion_id). The second analysis index (PMI_idx) is set by combining the first analysis index (PM_idx) and the motion execution index (motion_idx).

In this way, when the basic index and the analysis index are set, the controller 250 applies the indexes to each operational data received from the collaborative robot 100 and stores the same in the memory 250. When the operational data to which the indexes are applied is stored at a threshold value or more, the controller 250 detects a fault associated with the operation of the collaborative robot 100 by comparing the same using a plurality of operational data based on the indexes. The controller 250 may identify the cause of a fault more accurately by tracing back the program and motion corresponding to the detected fault, and display the identified fault and cause of the fault on the display 230.

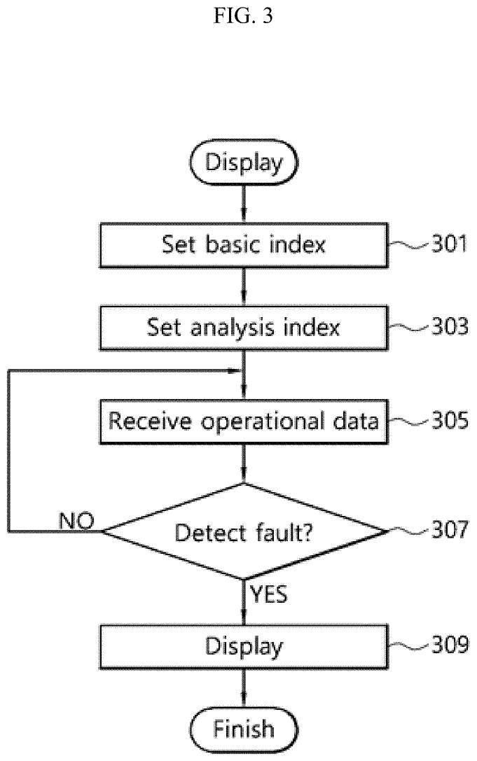

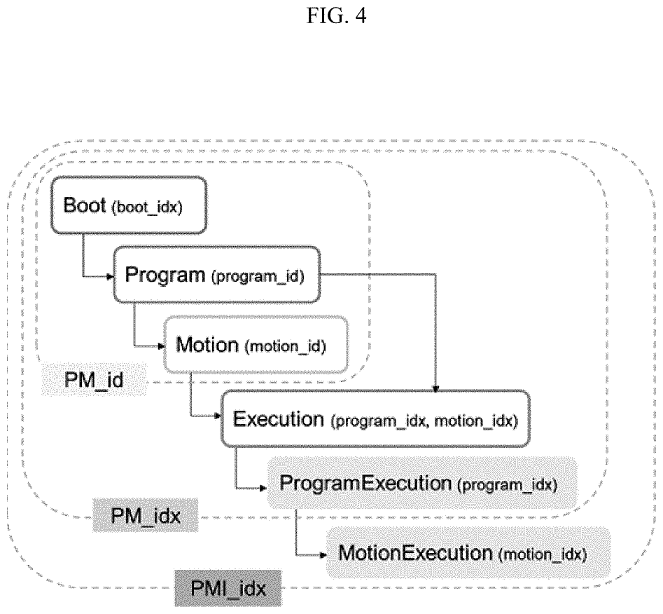

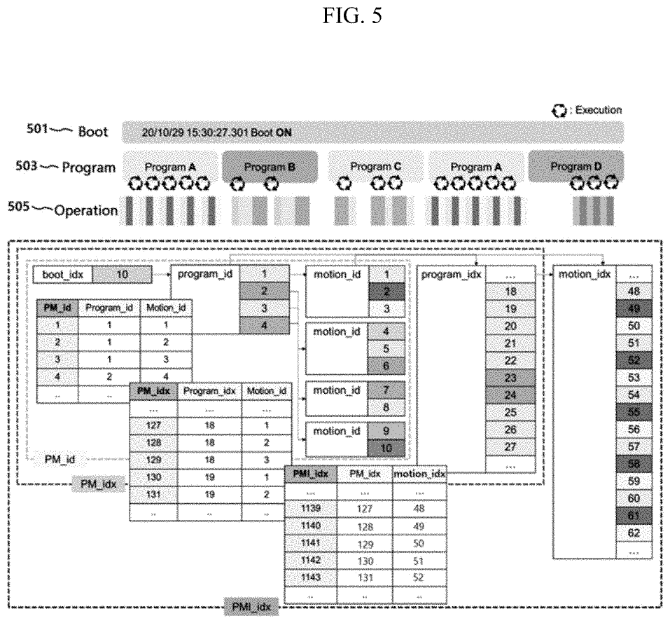

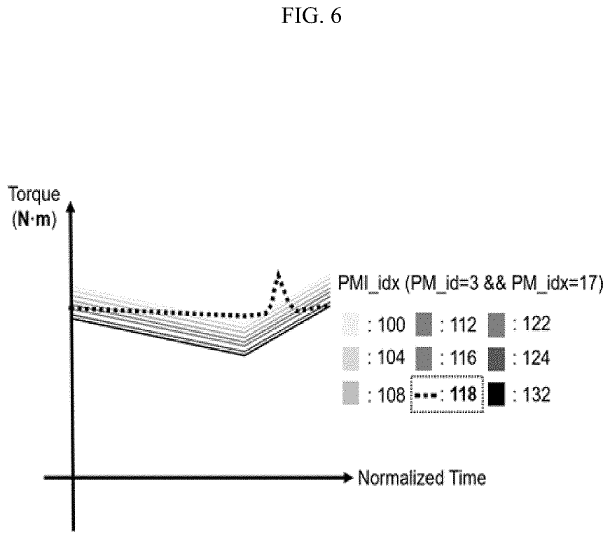

FIG. 3 is a flowchart illustrating the method for tracing a fault of a collaborative robot according to an exemplary embodiment of the present invention. FIG. 4 is a diagram for describing an index hierarchical structure set in operational data received from a collaborative robot according to an exemplary embodiment of the present invention. FIG. 5 is a diagram for describing the operational situation of a collaborative robot in an index hierarchical structure according to an exemplary embodiment of the present invention. FIG. 6 is a diagram showing the result of analyzing the operational data of a collaborative robot according to an exemplary embodiment of the present invention.

Referring to FIGS. 3 to 6, since the collaborative robot 100 performs various motions according to various programs, in order to determine the normal section and the fault section during the operation of the collaborative robot 100, it is necessary to systematically establish the unit of analysis of the operational data. To this end, the controller 250 sets the basic index and the analysis index through steps 301 and 305. Through this, the controller 250 may check the start and end of the operation of the collaborative robot 100, and confirm the type of program which is repeatedly executed during operation, the number of repetitions of internal motions constituting the program and the like.

In steps 301 and 303, the controller 250 creates an index hierarchy structure as shown in FIG. 4 to set a basic index and an analysis index.

More specifically, the controller 250 sets a section from the time when the power of the collaborative robot 100 is turned on to the time when the power is turned off as a boot index (boot_idx), sets the type of program to be executed until the power of the collaborative robot 100 is turned on and off as a program ID (program_id), sets the unit of the motion constituting each program as a motion ID (motion_id), sets the unit for executing any one of the motions constituting the program as an execution index (program_idx, motion_idx), sets a program execution index (program_idx) in which a program corresponding to the program ID (program_id) is executed, and sets a motion execution index (motion_idx) in which a motion corresponding to the motion ID (motion_id) is executed as a basic index.

Next, in order to detect a fault of the collaborative robot 100, the controller 250 must group data performed under the same conditions, that is, the same program (program_idx) and the same motion (motion_idx). Therefore, the controller 250 sets the analysis unit as an analysis ID (PM_id), sets the unit for each program execution having the same analysis ID (PM_id) as a first analysis index (PM_idx), and sets the execution section of the motion as a second analysis index (PMI_idx).

In this case, the analysis ID (PM_id) refers to an ID assigned to a motion which is dependent on the performed program. That is, the analysis ID (PM_id) is set by combining the program ID (program_id) and the motion ID (motion_id) dependent on the program ID (program_id). The first analysis index (PM_idx) is set by combining the program execution index (program_idx) and the motion ID (motion_id). The second analysis index (PMI_idx) is set by combining the first analysis index (PM_idx) and the motion execution index (motion_idx).

In step 305, the controller 250 receives operational data from the collaborative robot 100 and performs step 307. In step 307, the controller 250 confirms whether a fault associated with the operation of the collaborative robot 100 is detected using the received operational data and the index set in steps 301 and 303. As a result of the confirmation in step 307, if there is not enough operational data stored to detect a fault, the controller 250 returns to step 305 to continuously receive operational data of the collaborative robot 100.

More specifically, the controller 250 may assign an index to the operational data received from the collaborative robot 100 as shown in FIG. 5, and check the operation status of the collaborative robot 100 based on the assigned index. Referring to FIG. 5, the controller 250 may confirm that the collaborative robot 100 was powered on at 2020 Oct. 29 15:30:27.301 based on boot information 501, and confirm from programming information 503 that four different programs (Program A, Program B, Program C, Program D) were driven from the time when the power was turned on to the time when the power was turned off. In addition, the controller 250 may confirm that Program A was repeatedly driven 5 times including 3 motions, Program B was repeatedly driven 2 times including 3 motions, Program C was repeatedly driven 3 times including 2 motions, and Program D was repeatedly driven 3 times including 2 motions. For this reason, the controller 250 may confirm that Program A was driven times, Program B was driven 2 times, Program C was driven 3 times and Program D was driven 3 times for a total of 18 times, while the collaborative robot 100 was operated.

The controller 250 assigns an index to such operational data. For example, the controller 250 assigns one boot index (boot_idx) and assigns IDs to each of Programs A to D to assign a total of four program IDs (program_id). The controller 250 assigns an ID to each motion dependent on each program to assign a total of 10 motion IDs (motion_id). Since the programs were executed a total of 18 times while the collaborative robot 100 was operated, the controller 250 assigns 18 program execution indexes (program_idx). Since a total of 48 motions were executed while the collaborative robot 100 was operated, the controller 250 may assign 48 motion execution indexes (motion_idx).

In addition, the controller 250 may assign 10 analysis IDs (PM_id), 13 first analysis indexes (PM_idx) and 48 second analysis indexes (PMI_idx) according to the combination of the program and motion. For example, three motions are dependent on Program A and Program B, and two motions are dependent on Program C and Program D. Accordingly, as illustrated in FIG. 5, the controller 250 assigns 10 analysis IDs (PM_id) by respectively combining program_id 1 and motion_id 1, program_id 1 and motion_id 2, program_id 1 and motion_id 3, program_id 2 and motion_id 4, program_id 2 and motion_id 5, program_id 2 and motion_id 6, program_id 3 and motion_id 7, program_id 3 and motion_id 8, program_id 4 and motion_id 9, and program_id 4 and motion_id 10.

The controller 250 assigns a first analysis index (PM_idx) by combining the program execution index (program_idx) and the motion ID (motion_id). In this case, in the case of Program A, since it was executed twice while the collaborative robot 100 was operated, the first analysis index (PM_idx) is assigned only once. Accordingly, the controller 250 may assign 13 first analysis indexes (PM_idx). The controller 250 assigns 48 second analysis indexes (PMI_idx) by combining the first analysis index (PM_idx) and the motion execution index (motion_idx).

As a result of the confirmation in step 307, if a fault is detected, the controller 250 performs step 309 and displays the detection result on the display 230. More specifically, FIG. 6 is a sampling result obtained by the controller 250 by standardizing execution start times for all indexes to 0 in 9 second analysis indexes (PMI_idx) for the same execution section where the analysis ID (PM_id) is 3 or the first analysis index (PM_idx) is 17. That is, as a result of grouping and analyzing the operational data for executing the same motion, the controller 250 may check a dotted line graph showing a difference between torque values of different patterns in which the torque values are different. The controller 250 may confirm that the value corresponding to the dotted line graph is No. 118 of the second analysis index (PMI_idx). Through this, the controller 250 may trace back the program and motion corresponding to No. 118 of the second analysis index (PMI_idx) to identify the cause of a fault more accurately.

The exemplary embodiments of the present invention disclosed in the present specification and drawings are only provided for presenting specific examples to easily describe the technical contents of the present invention and help the understanding of the present invention, and are not intended to limit the scope of the present invention. Accordingly, the scope of the present invention should be construed as including all changes or modifications that are derived based on the technical spirit of the present invention, in addition to the exemplary embodiments disclosed herein.

1. A method for tracing a fault of a collaborative robot, comprising the steps of:
setting, by an electronic device, a basic index which serves as an analysis criterion of operational data generated by the collaborative robot;
setting, by the electronic device, an analysis index for analyzing the operational data;
receiving, by the electronic device, a plurality of operational data from the collaborative robot; and
tracing, by the electronic device, a fault generated in at least one of the plurality of operational data using the basic index and the analysis index.

2. The method of claim 1, wherein the step of setting the basic index is setting a boot, a program ID, a motion ID, an execution index, a program execution index and a motion execution index associated with the operation of the collaborative robot as the basic index.

3. The method of claim 2, wherein the step of setting the analysis index is setting an analysis ID that combines the program ID and the motion ID, a first analysis index that combines the program execution index and the motion ID, and a second analysis index that combines the first analysis index and the motion execution index.

4. The method of claim 3, wherein the step of tracing the fault comprises:
assigning, by the electronic device, the basic index and the analysis index to each of the plurality of operational data.

5. The method of claim 4, further comprising:
after the step of assigning the basic index and the analysis index,
confirming, by the electronic device, a second analysis index having the same analysis ID from among the analysis indexes assigned to each of the plurality of operational data.

6. The method of claim 4, further comprising:
after the step of assigning the basic index and the analysis index,
confirming, by the electronic device, a second analysis index having the same first analysis index from among the first analysis indexes assigned to each of the plurality of operational data.

7. The method of claim 5, further comprising:
confirming each of a plurality of data values for each of a plurality of operational data corresponding to the confirmed second analysis index;
confirming a data value which is different by a threshold or more from among the plurality of data values; and
tracing the fault by confirming programs and motions associated with the confirmed data value.

8. An apparatus for tracing a fault of a collaborative robot, comprising:
a communicator for receiving a plurality of operational data from the collaborative robot; and
a controller for setting a basic index which serves as an analysis criterion of the operational data and an analysis index for analyzing the operational data, and tracing a fault generated in at least one of the plurality of operational data using the basic index, the analysis index and the plurality of operational data.

9. The apparatus of claim 8, wherein the basic index comprises a boot, a program ID, a motion ID, an execution index, a program execution index and a motion execution index associated with the operation of the collaborative robot.

10. The apparatus of claim 9, wherein the analysis index comprises an analysis ID that combines the program ID and the motion ID, a first analysis index that combines the program execution index and the motion ID, and a second analysis index that combines the first analysis index and the motion execution index.

11. The apparatus of claim 10, wherein the controller assigns the basic index and the analysis index to each of the plurality of operational data.

12. The apparatus of claim 11, wherein the controller respectively confirms a second analysis index having the same analysis ID or the same first analysis index from among the analysis indexes assigned to each of the plurality of operational data.

13. The apparatus of claim 12, wherein the controller confirms each of a plurality of data values for each of a plurality of operational data corresponding to the confirmed second analysis index.

14. The apparatus of claim 13, wherein the controller traces the fault by confirming programs and motions associated with a data value which is different by a threshold or more from among the plurality of confirmed data values.
